(19) United States
(12) Patent Application Publication
(10) Pub. No.: US 2003/0202575 A1
(43) Pub. Date: Oct. 30, 2003

(54) System and method for digital video frame scanning and streaming

(76) Inventors: Billy Dennis Williams, Lee, NH (US); Reuben Bruce Murphy, Portsmouth, NH (US)

Correspondence Address: Michelle S. Temple, Temple Patent Law Office, 57 Hackleboro Road, Canterbury, NH, 03224, US

(21) Appl. No.: 10/115,291

(22) Filed: Apr. 3, 2002

(51) Int. Cl. H04N 7/12

(52) U.S. Cl. 375/240.01; 375/240.25

(57) ABSTRACT

A computer system executable method for use in transmitting digital video stream from a transmitting device to at least one receiving device. The method includes sending a first frame to at least one receiving device, comparing a first frame and a second frame for changed pixels, determining changed and unchanged pixels, coding said pixels to indicate the changed and unchanged pixels, transmitting the code to the at least one receiving device, and decoding the code and viewing the second frame on the at least one receiving device. The present invention also includes a computer system executable method for transmitting a digital video stream from a transmitting device to at least one receiving device where the method includes dividing a first frame and a second frame into corresponding sections, comparing each section for changed pixels, determining a changed pixel in one of the second frame sections, transmitting the section to said at least one receiving device, and integrating the section into the first frame. Also included is a combination of the methods.

### FIELD OF THE INVENTION

This invention relates to the field of data transmission.

### BACKGROUND OF THE INVENTION

Data flow requirements for transmitting raw video information over a network generally exceeds the capacity of a network. Data must be buffered and routed through data sockets in the TCP/IP stack of the transmitting digital device, transmitted over the limited network bandwidth, rerouted and re-buffered on the receiving digital device. Each network component acts as a data flow constraint that becomes a severe bottleneck in effectively regenerating the video display on the receiving digital device.

The transmission of short—or low resolution video clips is accommodated relatively well by current networking constraints. It is when more complex images become transmitted that networking difficulties occur.

Technology currently found in the art includes the use of video streaming. This involves transmitting and buffering the information (data file), then processing the data with a video application (such as a media player) running on the receiving digital device while the data is being buffered in the receiving computer's memory. Such video streaming also has constraints given that the data processing for the video display can exceed the rate that the data is received in the buffer.

Even more complex video transmissions must be sent to the receiving digital device and stored in memory as file data. These file transfers take time, as enormous amounts of data must be transmitted, causing excessive delays. In turn, this negates real-time transmission of video information. Such transmissions need to be sent, then stored on the receiving digital device's RAM or memory hard drive, as code memory, before being played. Once downloaded (for example, in the case of a feature film the downloading can take more than a half hour), the transmission can be played. Of course, this assumed that the receiving digital device has sufficient memory storage space available or that storage of such files is even desired. True, real-time screening is therefore severely constrained in the current art.

Accordingly, developers have great interest in finding a more efficient means of transmitting video information over a digital device network. Additionally, there is a great interest in eliminating the need to store video data on the receiving digital device's storage device. Thus, the overall object is to maximize the video resolution while transmitting data within the flow constraints of the network.

Function call video splicing is one technique currently available in the art. This technique uses the transmission of function calls recognized by an operating system or an application running on an operating system. This networking configuration requires compatible software running on both the transmitting and receiving digital devices. The function call then instructs the software to perform tasks that may change the VRAM and corresponding video display of the receiving computer. In this instance, no actual video data is transmitted over the network. The software actually utilizes its own database and object code to generate the changes in the video display.

Compression is another technique currently available in the art. Video compression techniques are used in two major categories: data compression and video file compression. Describing data compression first, data compression involves manipulating raw video with a compression algorithm. The transmitting digital device enters data into a compression layer that then reformats the information into a specific sequence that is generally shorter than the original one. In a simplified example of compression, 5 red pixels in a row can be represented with a Red/Green/Blue (RGB) color system by “5(R1G0B0)” as opposed to the original sequence of “(R1G0B0), (R1G0B0), (R1G0B0), (R1G0B0), (R1G0B0)”. Advanced algorithms have more efficient techniques for compressing complex data sequences.

The compression techniques described here are not inherent to video data and can be used for any form of data sequence. However, certain compression algorithms achieve greater compression ratios for video information than general-purpose compression algorithms.

The second category of video compression is video file compression. With this technique, compression algorithms are embedded in the file format. MPEG is an example of this technology. The video bitmaps (i.e. frames) are saved in the compressed file format. When the video application processes the video file, it reformats the data for display in a decompressed format. Accordingly, the video file compression and decompression processes occurs when video data is saved in that format or accessed for processing in the stored memory respectively.

In contrast, general data compression is utilized as layers in a digital device network architecture or storage systems. Both systems of compression can be utilized, however, adding subsequent rounds of data compression either creates marginal efficiencies, or results in greater inefficiencies, depending on the character of the respective compression algorithms, when these algorithms are utilized in tandem.

Another video data transmission technology currently known in the art includes sectional image scanning and selective transmission. In this technology, the screen bitmap (e.g. 640×480) is divided into smaller sections (e.g. 12 sections that are 160×160 each). In a video sequence, the pixel values for the bitmap are stored in memory. A conventional algorithm scans the bitmap for any changes by comparing it with the bitmap that is stored in memory.

Typically, the image scanning begins from a corner of the image and proceeds pixel-by-pixel and row-by-row until it detects a change. These screen checks are currently performed as few times as desired, or as many as between eight (8) and approximately eighty (80) times per second, depending upon processor speed. Once it detects a change, the algorithm proceeds to transmit the data for the corresponding image section in which the change occurs. However, the screen check then loops back to the beginning section and starts the screen check again. Thus, using this technique, the top areas of the screen are checked more often then the bottom areas of the screen. Although this technique eliminates the transmission of the entire screen image to regenerate the images on the receiving digital device, the complete image is never evenly updated. Instead, only the top sections of the screen are regularly checked for changes and those changes transmitted disproportionately more than the remainder of the screen. This image refresh disparity results in “choppiness” and other distortions of the regenerated video image.

U.S. Pat. No. 6,285,791 discloses a transmission method for video or moving pictures by compressing block differences. The video image is encoded at the sending end, transmitted, and decoded at the receiving end. The first frame is compressed and transmitted to the receiving end where it is stored in image memory. A copy of the first frame is retained at the transmitting end and divided into blocks. The next frame is also divided into blocks. The blocks of the first frame and the blocks of the next frame are compared to determine a block difference for each block. For each block, the difference between successive blocks is compressed and transmitted if the block difference for the block exceeds a predetermined threshold. The method compares the luminance component of the pixels within a block area, and does not compare the full image as a whole.

Although this method allows for comparative screening of successive video frames, and allows for only updates to be sent to the receiving device, this method has a significant drawback. Because this method depends on the luminance component of the pixels within a block area, this method does not allow for true pixel-by-pixel screening and updating based on a single pixel change. Accordingly, this method results in degradation of the regenerated video image as a result of a loss of original data integrity.

Therefore, there is still a need in the art for a system and method for transmitting raw video information over a network that is both efficient and does not sacrifice the integrity of the data. A system and method for comparing an image on the transmitting digital device and sending the receiving digital device changes that is not based solely on a block method, is not based on a luminescence method, and performs a scan of the entire image, during each scan, is still desired in the art.

### SUMMARY OF THE INVENTION

In accordance with one aspect of the invention, a computer system executable method for use in transmitting digital video stream from a transmitting device to at least one receiving device. This method includes sending a first frame to at least one receiving device, comparing a first frame and a second frame for changed pixels, determining changed and unchanged pixels, coding the pixels to indicate the changed and unchanged pixels, transmitting the code to the at least one receiving device, and decoding the code and viewing the second frame on said at least one receiving device.

Implementation of this aspect of the invention may include one or more of the following features. Comparing each bit of the pixels and generating a code for each bit of the pixels. Also, scanning each pixel in the first frame and scanning each corresponding pixel from the second frame and performing a logic function on each of the pixels, whereby the logic function determines the changed and unchanged pixels. This aspect of the invention may additionally include establishing an alternation pattern and scanning pixels corresponding to the alternation pattern in the first frame and scanning pixels in the second frame corresponding to the pixels in the first frame and performing a logic function on each of the pixels, whereby the logic function determines the changed and unchanged pixels. Further features that might be included in this aspect of the invention include compressing the code and decompressing the code.

In accordance with another aspect of the invention, a computer system executable method for use in transmitting digital video stream from a transmitting device to at least one receiving device. The method includes storing a first frame in a reference memory in the transmitting device, compressing the first frame, transmitting the first frame to the at least one receiving device, decompressing the first frame on at least one receiving device, storing a second frame in a reference memory in the transmitting device, comparing pixels in the first frame to corresponding pixels in the second frame, determining changed and unchanged pixels from the first frame to the second frame, based on the comparing and determining, generating a code to represent the changed and unchanged pixels, compressing the code, transmitting the code to the at least one receiving device, decompressing the code on at least one receiving device, and decoding the code and viewing the second frame on the at least one receiving device.

Such a method may include one or more of the following features. Comparing each bit of the pixel to each bit of the corresponding pixel and generating a code for each bit of the pixel. Additionally, this method may also include scanning each pixel in the first frame and scanning each corresponding pixel from the second frame and performing a logic function on each of the pixels, whereby the logic function determines the changed and unchanged pixels. Also, establishing an alternation pattern and scanning pixels corresponding to the alternation pattern in the first frame and scanning pixels in the second frame corresponding to the pixels in the first frame and performing a logic function on each of the pixels, whereby the logic function determines the changed and unchanged pixels.

In accordance with another aspect of the invention, a computer system executable method for use in transmitting digital video stream from a transmitting device to at least one receiving device. The method includes dividing a first frame and a second frame into corresponding sections, comparing each section for changed pixels, determining a changed pixel in one of the second frame sections, transmitting the section to at least one receiving device, and integrating the section into the first frame.

Such a method may include one or more of the following features. Comparing bits of said pixels; compressing the section; or performing a logic function on each of the pixels, whereby the logic function determines the changed pixels. Additionally, the method may include establishing an alternation pattern and scanning pixels corresponding to the alternation pattern in the first frame and scanning pixels in the second frame corresponding to the pixels in the first frame and performing a logic function on each of the pixels, whereby the logic function determines the changed pixels.

In accordance with another aspect of the invention, a computer system executable method for use in transmitting digital video stream from a transmitting device to at least one receiving device. The method includes dividing a first frame and a second frame into corresponding sections, storing the first frame in a reference memory in the transmitting device, compressing the first frame, transmitting the first frame to at least one receiving device, decompressing the first frame on at least one receiving device, storing the second frame in a reference memory in the transmitting device, comparing pixels in a first section of the first frame to a corresponding section in the second frame, determining a changed pixel from a difference in at least one pixel between the first section of the first frame to the corresponding section in the second frame, if the changed pixel determined, compressing the corresponding section in the second frame, transmitting the corresponding section in the second frame to at least one receiving device, decompressing the corresponding section, integrating the decompressed corresponding section into the first frame stored in the reference memory of at least one receiving device, storing the integrated first frame in the reference memory, and repeating this process with another pair of sections subsequent to the previously processed pair of sections until each section of the first frame and the second frame has been processed.

Such a method may include one or more of the following features. Comparing bits of the pixels. Performing a logic function on each of the pixels, whereby the logic function determines the changed pixel. Establishing an alternation pattern and scanning pixels corresponding to the alternation pattern in the first frame and scanning pixels in the second frame corresponding to the pixels in the first frame and performing a logic function on each of the pixels, whereby the logic function determines the changed pixel.

In accordance with another aspect of the invention, a computer system executable method for use in transmitting digital video stream from a transmitting device to at least one receiving device. The method includes completing a first processing, the first processing includes, compressing a first frame of the video stream, sending the first frame to the receiving device, comparing a first frame and a second frame for changed pixels, determining changed and unchanged pixels, coding the pixels to indicate the changed and unchanged pixels, compressing the code, and storing the code in a first buffer. Completing a second processing, the second processing includes, dividing the first frame and second frame into corresponding sections, comparing each section for changed pixels, determining a changed pixel in one of the second frame sections, transmitting the section to a second buffer, compressing the second buffer, determining a compression ratio for each of the first buffer and the second buffer, and sending the buffer with a greater compression ratio to at least one receiving device. If the first buffer is sent, the method further includes decompressing the first buffer and decoding the code and viewing the second frame on at least one receiving device. If the second buffer is sent, the method further includes decompressing the second buffer and integrating the section into the first frame on at least one receiving device and viewing the second frame on at least one receiving device.

Such a method may include one or more of the following features. Comparing bits of said pixels. Additionally, the method may include scanning each pixel in the first frame and scanning each corresponding pixel from the second frame and performing a logic function on each of the pixels, whereby the logic function determines the changed and unchanged pixels. The method may also include establishing an alternation pattern and scanning pixels corresponding to the alternation pattern in the first frame and scanning pixels in the second frame corresponding to the pixels in the first frame and performing a logic function on each of the pixels, whereby the logic function determines the changed pixel.

### BRIEF DESCRIPTION OF THE DRAWINGS

These aspects of the invention are not meant to be exclusive and other features, aspects, and advantages of the present invention will be readily apparent to those of ordinary skill in the art when read in conjunction with the appended claims and accompanying drawings.

FIG. 1A is a flow diagram representing the preferred embodiment of the transmitting digital device XOR video streaming method of the present invention.

FIG. 1B is a flow diagram representing the preferred embodiment of the receiving digital device XOR video streaming method of the present invention.

FIG. 2A is a flow diagram representing the preferred embodiment of the sectional image scanning method for the transmitting device of the present invention.

FIG. 2B is a flow diagram representing the preferred embodiment of the sectional image scanning method for the receiving device of the present invention.

FIG. 3 is a flow diagram representing the preferred embodiment of the process of running XOR and sectional image scanning simultaneously.

FIG. 4A is a flow diagram representing the preferred embodiment of the bird's eye view method for the transmitting device of the present invention.

FIG. 4B is a flow diagram representing the preferred embodiment of the bird's eye view method for the receiving device of the present invention.

FIG. 5 is a flow diagram representing the process of running XOR and bird's eye view scanning processes simultaneously.

### DETAILED DESCRIPTION OF THE INVENTION

The present invention is a method and system for digital video frame scanning and screening an entire set of pixels represented on a digital device screen at time instant t, where the screen contains i rows and j columns of pixels. The invention, in the XOR embodiment, detects the pixels, which have changed between time t and t+1, and transmits only the changes to the receiving digital device. The invention first scans screen image 1, located on the transmitting digital device, represented as Aᵢⱼ(t). Next, the invention scans the update of screen image 1 represented by Aᵢⱼ(t+1). The invention checks each bit within Aᵢⱼ(t) and Aᵢⱼ(t+1) and through a series of logical operations, determines the differences within each pixel element caused by the update. Differences are given a value of 1 (binary one) by the XOR function or 0 respectively with other embodiments, and these differences are compressed and sent to the receiving digital device. Where no differences are found, a stream of zeros is created by the XOR function or 1's respectively for other embodiments for that element of the array representing the screen image.

The present invention additionally includes a sectional image transmission operation as another embodiment to the invention. This operation divides the screen image into sections and scans the image of the transmitting digital device beginning at one location (starting point) of the image. This operation samples for pixel changes within a certain section. When a change in the section of the screen image is found, the sectional image transmission module sends this updated section to the receiving digital device. The sectional image transmission operation then continues the scanning process beginning from the section last transmitted, until the entire screen image has been scanned for changes. The operation then starts again at the starting point of the screen image. In another embodiment of the invention, both the XOR embodiment and the section image embodiment are run simultaneously. In another embodiment of the invention, the bird's eye view, the sampling is done using a predetermined alternation pattern.

The embodiments of the invention described herein are implemented as logical operations in a digital device system. The logical operations of the present invention are implemented (1) as a sequence of digital device implemented steps running on the digital device and (2) as interconnected digital modules within the digital device's system. The implementation is a matter of choice dependent on the performance requirements of the digital device system implementing the invention. In this manner, as many buffers and as few buffers are implemented as are required to support each step running on each digital device. Accordingly, the logical operations making up the embodiments of the invention described herein are referred to variously as operations, steps, functions or modules.

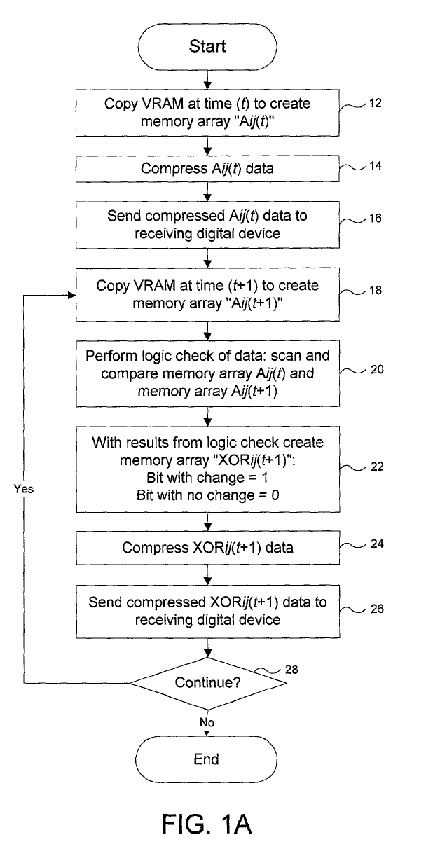

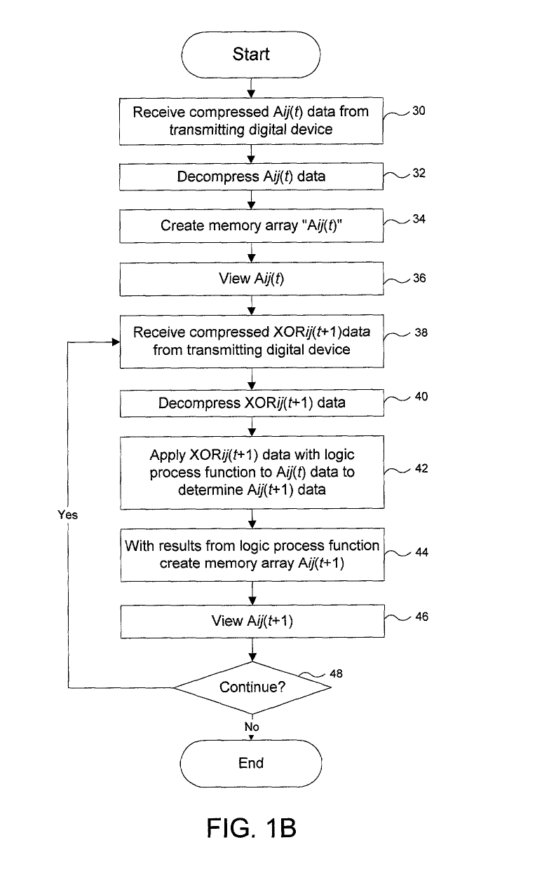

Referring first to FIG. 1A, a representation of the preferred embodiment of the XOR video streaming process of the transmitting device of the present invention is shown. In the preferred embodiment of the invention, the present invention is running on both a transmitting digital device and a receiving digital device. The digital device can be any digital device currently known in the art. The digital devices are connected by a data linkage, which, in the preferred embodiment is Internet or Ethernet. Each digital device has a screen where the video streaming is shown.

Each screen image contains a number of pixels. For purposes of illustration of the present invention, Aij(t) and Bij(t) are a matrices representing the entire set of pixels represented on the device screen at time instant t and row identities (i=1, 2, . . . , m) and column identities (j=1, 2, . . . , n) represent each pixel. The variables m and n vary depending upon the screen capabilities and settings of the screen where the video streaming is viewed. The present invention can be used on any type of digital device screen of the type currently known to those of ordinary skill in the art.

Still referring to FIG. 1A, the process beings at step 12, where a video random access memory array (VRAM) is copied at time (t) to create a memory array Aij(t). In other embodiments, other stored digital video information is copied. This array represents frame 1/screen image 1 of the sequential video images running in VRAM. Each element in the array, i.e., each pixel in the screen image, in some embodiments, is filled with a 1-bit specification representing black and white. In alternative embodiments, a higher bit specification is coded to represent grayscale or color. In the preferred embodiment, color bit specifications represent the amount of red, blue, and green that is to be displayed at time period t. However, in alternate embodiments, any size bit code can be used with the current invention. The memory array will include the bit code for each pixel that makes up one frame of a video screen image. In step 14, the data in array Aij(t) is compressed, and then in step 16, the compressed array is sent to the receiving digital device.

Next, in step 18, the VRAM is copied at time (t+1) to create a memory array Aij(t+1). In step 20, a logic check is performed on both arrays, Aij(t) and Aij(t+1). In the preferred embodiment, the “exclusive or” function from any C language including C++ language performs the logical check on both arrays. However, in other embodiments, a “+” and “−” function can be used, or any other function that results in a similar operation that is known in the art. In other embodiments, the language used is not C, but rather any other languages commonly used in the art. The methods of the present invention can be performed using several mathematical processes, including simple addition and subtraction of integers or more complex matrix algebra.

In step 20, the logical process is used to determine the pixels that have changed between t and t+1. The process in step 20 is as follows. All of the pixel data at the bit level is sampled. The alternative embodiments of the sampling process can be any process known in the art. In the preferred embodiment, the logical process in step 20 can be the sampling of first the red, then the blue and then the green bit codes for every pixel of the screen image together.

In step 22, the results of the logical process are used to create a new memory array XORij(t+1). In this array, every bit that is determined to have changed in step 20 is assigned a binary value of 1, and every bit that is determined not to have changed in step 20 is assigned a binary value of 0. In other embodiments, the vice-versa coding is used, i.e., 1 is assigned for bits that have not changed, and 0 is assigned for bits that have changed. Thus, even where pixel changes are found, the sample contains both “no change” data and “pixel change” data within the same sample.

Accordingly the data sequence in the memory array XORij(t+1) consists of data patterns that achieve a very high compression ratio when compressed in step 24 by any data compression algorithm known in the art, thus leveraging the compression capabilities of a conventional data algorithm. When the color specification of Aij(t+1) has not changed from Aij(t), sampling of the red, blue, and green bit codes for each pixel together in step 22 results in even greater data patterns that achieve higher compression ratios with any data compression algorithm known in the art.

The effect of the operation of the invention is to transmit only the pixel changes anywhere in a video screen image. This results in real-time viewing on the receiving digital device within the existing network constraints. In step 26, the compressed XORij(t+1) array data is sent to the receiving digital device. If the video streaming process is continued, as determined in step 28, then the process is repeated, beginning with step 18, when a new memory array is copied from VRAM at time (t+2). This process is again repeated, beginning with step 18, for (t+3), (t+4) . . . (t+X) until it is discontinued, as determined in step 28.

The XOR process shown in FIG. 1A is repeated any number of times, however, currently the maximum processing capability is between eight (8) and eighty (80) times per second. The present invention can accommodate black and white, or, any bit specification of colors, and where different colors arise between the operating system of the transmitting device, and the receiving device, the present invention allows the application programmer to default to find the closest match.

Referring next to FIG. 1B, a representation of the preferred embodiment of the XOR video streaming process of the receiving digital device of the present invention is shown. The process begins at step 30, where the compressed Aij(t) array data is received from the transmitting digital device. In step 32 the receiving digital device decompresses the Aij(t) array data and, in step 34, this decompressed data is used to create memory array Aij(t). The Aij(t) memory array can then be entered into the receiving digital device's VRAM by any video application known in the art, as represented in step 36. Once entered into VRAM, the frame 1/screen image 1 of the sequential video images running in VRAM on the transmitting digital device can be displayed and viewed on any display device known in the art that is operated by the receiving digital device.

Next, in step 38, the receiving digital device receives the compressed XORij(t+1) array data from the transmitting digital device. The receiving digital device decompresses the XORij(t+1) array data in step 40, and then in step 42, the receiving device performs the receiving XOR logic process by applying the XORij(t+1) array data to the Aij(t) memory array. The logic process is the exact inverse of the process used by the transmitting digital device to create the XORij(t+1) memory array. Each bit in the XORij(t+1) array that represents a change is applied to the respective bit in the Aij(t) memory array to produce the opposite binary value than was previously stored in the Aij(t) memory array.

The results of the XOR process are used to create the memory array Aij(t+1) in step 44 on the receiving digital device. This array consists of an identical data sequence to the Aij(t+1) memory array that was created on the transmitting digital device. The Aij(t+1) memory array can then be entered into the receiving digital device's VRAM by any video application known in the art, as represented in step 46. Once entered into VRAM, the frame 2/screen image 2 of the sequential video images running in VRAM on the transmitting digital device can be displayed and viewed on any display device known in the art that is operated by the receiving digital device.

If the video streaming process is continued, as determined in step 48, then the process is repeated, beginning with step 38, when a new compressed array is received from the transmitting digital device at time (t+2). This process is again repeated, beginning with step 38, for (t+3), (t+4) . . . (t+X) until it is discontinued, as determined in step 48.

The XOR process can also be used to store video information in a file format that results in very high file compression ratios. In this manner, the video random access memory array (VRAM) or other stored digital video information is copied on a storing digital device at time (t) to create a memory array Aij(t). This array represents frame 1/screen image 1 of the sequential video images running in VRAM. Each element in the array, i.e., each pixel in the screen image, in some embodiments, is filled with a 1-bit specification representing black and white. In alternative embodiments, a higher bit specification is coded to represent grayscale or color. In the preferred embodiment, color bit specification is coded to represent the amount of red, blue, and green that are to be displayed at time period t. However, in alternate embodiments, any size bit code can be used with the current invention. The memory array will include the bit code for each pixel that makes up one frame of a video screen image. The data in array Aij(t) is copied and compressed or simply compressed after the XOR process is completed for the Aij(t) array as described below. The compressed array Aij(t) is stored in the XOR video file as stored frame 1/stored screen 1.

Next, the VRAM is copied at time (t+1) to create a memory array Aij(t+1). A logic check is performed on both arrays, Aij(t) and Aij(t+1). In the preferred embodiment, the “exclusive or” function from any C language including C++ language performed the logical check on both arrays. However, in other embodiments, a “+” and “−” function can be used, or any other function that results in a similar operation that is known in the art. In other embodiments, the language used is not C, but rather any other language commonly used in the art. The methods of the present invention can be performed using several mathematical processes, including simple additional and subtraction of integers or more complex matrix algebra.

The logical process is used to determine the pixels that have changed between t and t+1. The process is as follows. All of the pixel data at the bit level is sampled. The alternative embodiments of the sampling process can be any process known in the art. In the preferred embodiment, the logical process can be the sampling of first the red, then the blue and then the green bit codes for every pixel of the screen image together.

The results of the logical process are used to create a new memory array XORij(t+1). In this array, every bit that is determined to have changed is assigned a binary value of 1, and every bit that is determined not to have changed is assigned a binary value of 0. In other embodiments, the vice-versa coding is used, i.e., 1 is assigned for bits that have not changed, and 0 is assigned for bits that have changed. Thus, even where pixel changes are found, the sample contains both “no change” data and “pixel change” data within the same sample.

Accordingly the data sequence in the memory array XORij(t+1) consists of data patterns that achieve a very high compression ratio when compressed by any data compression algorithm known in the art, thus leveraging the compression capabilities of a conventional data algorithm. When the color specification of Aij(t+1) has not changed from Aij(t), sampling of the red, blue, and green bit codes for each pixel together results in even greater data patterns that achieve higher compression ratios with any data compression algorithm known in the art.

The XORij(t+1) array is compressed and stored as XOR video file frame 2/screen 2. The effect of the operation of the invention is to store only the pixel changes anywhere in a video screen image.

If the video storing process is continued, then the process is repeated. This new process begins when a new memory array is copied from VRAM at time (t+2). This process is again repeated for (t+3), (t+4) . . . (t+X) until it is discontinued when the entire XOR video file is created.

The XOR video playback process beings when any playback digital device running any video application known in the art accesses the stored XOR video file information. The compressed Aij(t) array data is accessed in the XOR video file and converted into RAM memory if not already stored in RAM. The compressed Aij(t) array data is compressed using the decompression function of the same respective compression algorithm that was used to compress the array. This decompressed data is used to create memory array Aij(t). The Aij(t) memory array can then be entered into VRAM by the video application. Once entered into VRAM, the frame 1/screen image 1 of the sequential video images of the original VRAM can be displayed and viewed again on any display device known in the art that is operated by the playback digital device.

The playback digital device then, in timed sequence, accesses and decompresses the XORij(t+1) array data from the XOR video file. The playback digital device performs the playback XOR logic process by applying the XORij(t+1) array data to the Aij(t) memory array. The logic process is the exact inverse of the process used to create the XORij(t+1) memory array. Each bit in the XORij(t+1) array that represents a change is applied to the respective bit in the Aij(t) memory array to produce the opposite binary value than was previously stored in the Aij(t) memory array.

The results of the XOR process are used to create the memory array Aij(t+1) on the playback digital device. This array consists of an identical data sequence to the Aij(t+1) memory array that was originally created on the storing digital device. The Aij(t+1) memory array can be entered into the playback digital device's VRAM by any video application known in the art. Once entered into VRAM, the frame 2/screen image 2 of the sequential video images running in VRAM on the playback digital device can be displayed and viewed on any display device known in the art that is operated by the playback digital device.

If the video process is continues, then the process is repeated, when a new compressed array is accessed and decompressed on the digital device at time (t+2). This process is again repeated for (t+3), (t+4) . . . (t+X) until it is discontinued or when the entire XOR video file has been played back.

The XOR process described above and shown in FIG. 1A and FIG. 1B is most efficient in transmitting data for a series of small changes that are dispersed throughout the entire screen image. Because transmitting data in entire screen image sections can be more efficient when the screen image experiences major change affecting a large area of the screen, the preferred embodiment of the present invention additionally includes a sectional image transmission. Thus, in one embodiment of the present invention, a sectional image transmission is additionally buffered simultaneous to the XOR video streaming process described above. The present invention will transmit the buffer with the highest compression ratio for each screen image t and t+1. However, in other embodiments of the invention, either the XOR or the sectional image transmission is used independently for video streaming.

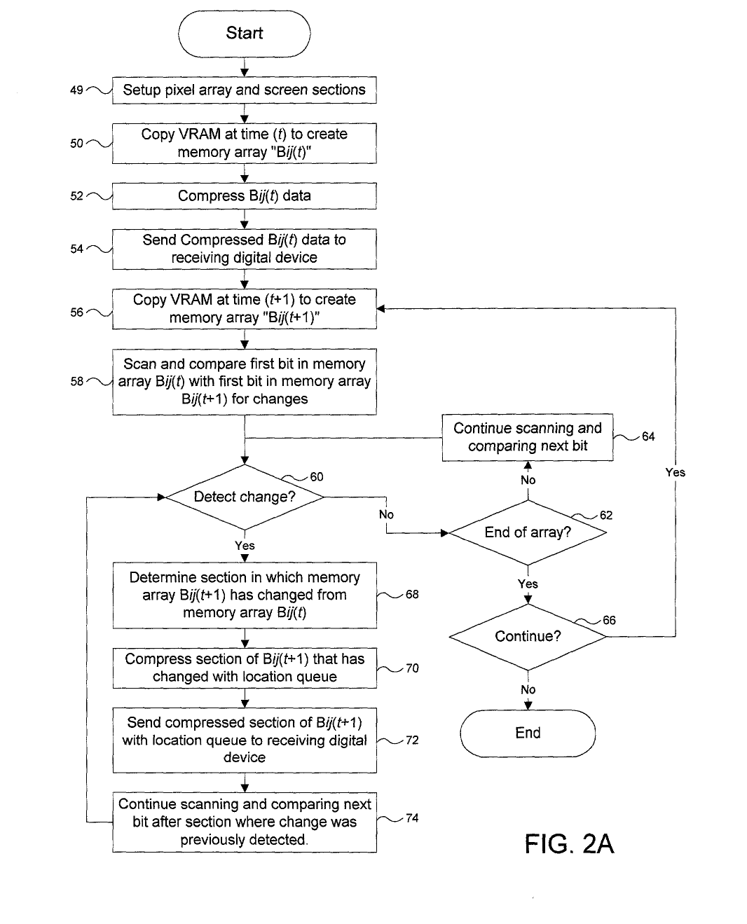

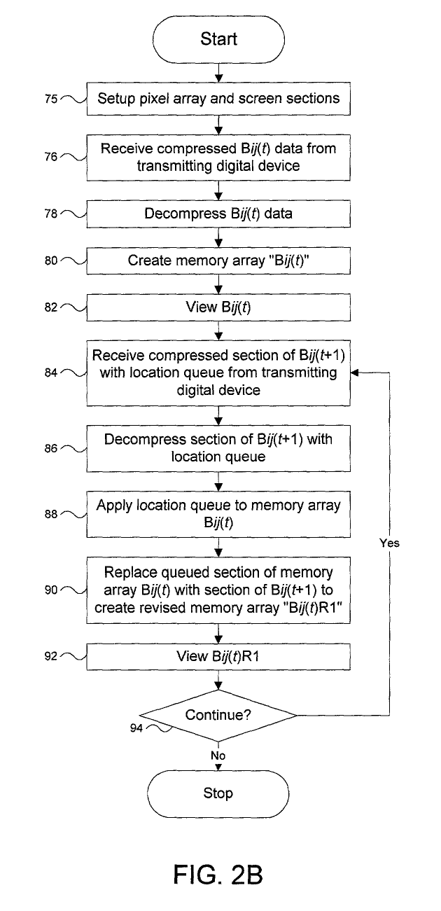

The sectional scanning process of the transmitting digital device is shown in FIG. 2A. The process begins at step 49, where the pixel array and screen sections are set up. In the preferred embodiment, these are predetermined sections on one big screen that are each defined by X-Y coordinates of the big screen. In an alternate embodiments, these are mini screens created when a dividing function takes one screen and turns it into several mini screens. These mini screens make up a “composite screen” which the viewer sees as one big screen. In other embodiments, any other process known in the art to divide the screen into sections can be used. Next, in step 50, the VRAM is copied at time (t) to create a memory array Bij(t). This array represents frame 1/screen image 1 of the sequential video images running in VRAM. In step 52, the data in array Bij(t) is compressed, and then in step 54, the compressed array is sent to the receiving digital device. If the mini screen embodiment is used in step 49, sending the Bij(t) image includes sending each and every mini section of the composite image.

Next, in step 56, the VRAM is copied at time (t+1) to create a memory array Bij(t+1). In step 58, a comparison check for any differences is performed on both arrays, starting with the first bit in memory array Bij(t+1) and comparing it with the corresponding bit in memory array Bij(t). This first bit corresponds to any corner of the screen image or any midpoint within the memory array that is designated a starting point. If no change in the first bit in Bij(t+1) is detected in step 60 relative to Bij(t), then the next bit is scanned in step 64. This process continues for each bit of each pixel until the end of the array is reached in step 62 or a change is detected in step 60. When the end of the array is reached in step 62 and the process is continued, as determined in step 66, then the process repeats beginning with step 58 until it is discontinued, as determined in step 66.

The Bij(t+1) memory array is divided into predetermined sections. In the preferred embodiment, the screen image is divided into 12 sections where each section is 160×160 pixels each. This, in essence, creates a screen image bitmap. However, in other embodiments, the screen can be divided into any number of sections, and following, the number of pixels and corresponding bits in each section will vary depending on the size of the screen, and the number of screen sections. Each section is defined by a predetermined location queue consisting of i values and j values or other code that identifies a subset of the memory array Bij and is recognized by both the transmitting digital device and the receiving digital device.

If a change is detected in step 60, then the section of Bij(t+1) in which the change occurred is determined in step 68. This data in this section, and the location queue of this section is compressed in step 70, and both are sent to the receiving digital device in step 72. Next, the comparison check process initiated in step 58 is continued in step 74 beginning with the next bit after the section where change was previously detected in step 60 of the previous cycle. This process continues a new cycle beginning with step 60.

Referring to FIG. 2B, a representation of the preferred embodiment of the sectional image scanning process of the receiving digital device of the present invention is shown. The process begins at step 75 where the pixel array and screen sections are set up. This step is identical to step 49, described above with reference to FIG. 2A, and includes all preferred and alternate embodiments as described above. Next, in step 76, the compressed Bij(t) array data is received from the transmitting digital device. In step 78 the receiving digital device decompresses the Bij(t) array data and, in step 80, this decompressed data is used to create memory array Bij(t). The Bij(t) memory array can then be entered into the receiving digital device's VRAM by any video application known in the art, as represented in step 82. Once entered into VRAM, the frame 1/screen image 1 of the sequential video images running in VRAM on the transmitting digital device can be displayed and viewed on any display device known in the art that is operated by the receiving digital device.

Next, in step 84, the receiving digital device receives the compressed section of the Bij(t+1) array data and the location queue data from the transmitting digital device. The receiving digital device decompresses the section of the Bij(t+1) array data and location queue data in step 86. In step 88, the receiving device determines, from the location queue data, the exact location of the section of the Bij(t+1) relative to the Bij(t) memory array. In step 90, the data from the queued section of memory array Bij(t) is replaced by the data from the section of Bij(t+1). This creates a revised memory array that is designated Bij(t)R1 in step 90.

The Bij(t)R1 memory array can then be entered into the receiving digital device's VRAM by any video application known in the art, as represented in step 92. Once entered into VRAM, the frame 1/screen image 1 of the sequential video images running in VRAM on the transmitting digital device can be displayed and viewed on any display device known in the art that is operated by the receiving digital device.

If the process is continued, as determined in step 94, then the process repeats beginning with step 84 until it is discontinued, as determined in step 94. Once all of the changed sections of Bij(t+1) are received and applied to the Bij(t) memory array, then revised Bij(t) memory array, represented by Bij(t)RX, will equal Bij(t+1) and can be viewed in step 94 as described above. This process is again repeated, beginning with step 84, for (t+3), (t+4) . . . (t+X) until it is discontinued, as determined in step 94.

Although the XOR process and the sectional image process use different scanning methods, each applies the same logic scanning processing, but changes are detected, transmitted, and received following the methods described above with respect to the XOR process.

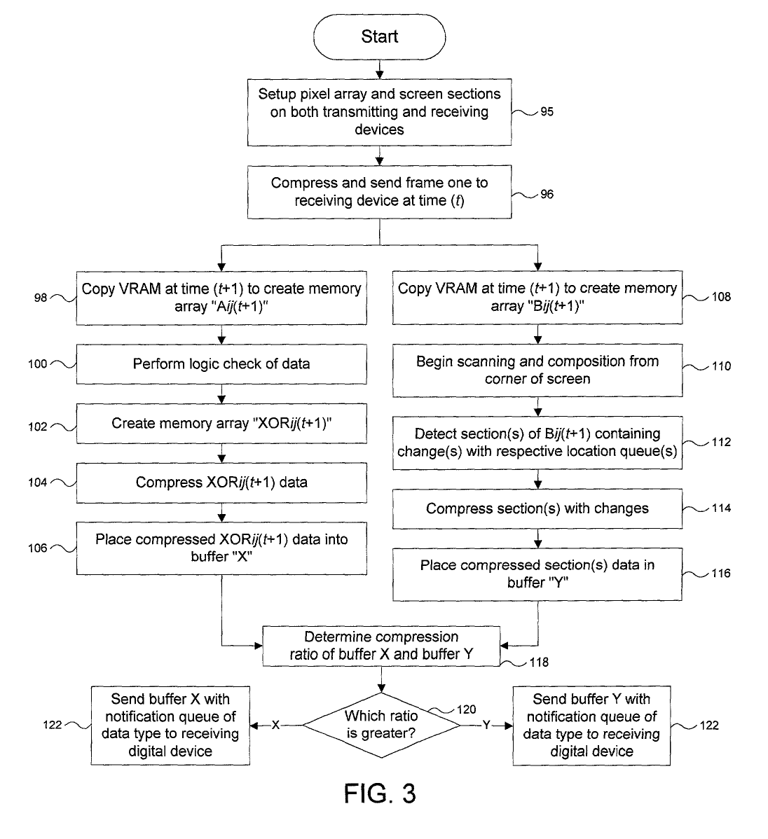

Referring next to FIG. 3, the process of utilizing both the XOR and the sectional image scanning processes simultaneously is shown. The process starts at step 95, where the pixel array and screen sections are set up. This step is identical to step 49, described above with reference to FIG. 2A, and includes all preferred and alternate embodiments as described above. Next, in step 96, when the transmitting digital device compresses and sends the first frame of the video file to the receiving digital device. The separate but simultaneous processing by the XOR, beginning with step 98, and the sectional image, beginning with step 108, then begins.

In step 98, the VRAM is copied at time (t+1) to create a memory array Aij(t+1). In step 100, a logic check is performed on both arrays, Aij(t) and Aij(t+1). The resulting data from the logical process in step 100 is used to create the new memory array XORij(t+I) in step 102 and this data is compressed in step 104 and placed in buffer X in step 106.

In step 108, the VRAM is copied at time (t+1) to create a memory array Bij(t+1). In step 110 Aij(t+1) array data is compared with Aij(t) array data to detect changes. In step 112, any sections where changes have been detected are identified and the data from each section is compressed in step 114. This compressed data is placed in buffer Y in step 116.

Next, in step 118, both the XOR process, beginning with step 98, and the sectional image process, beginning with step 108, merge, and the compression ratios for both buffer X and buffer Y are determined. In step 120, the buffer with the greatest compression ratio is selected. In step 122, the selected buffer is sent to the receiving digital device along with a predetermined notification queue consisting of an indicator of the type of data or other code that identifies the data as being either XOR data or sectional image data respectively. Both the transmitting digital device and the receiving digital device recognizes the notification queue.

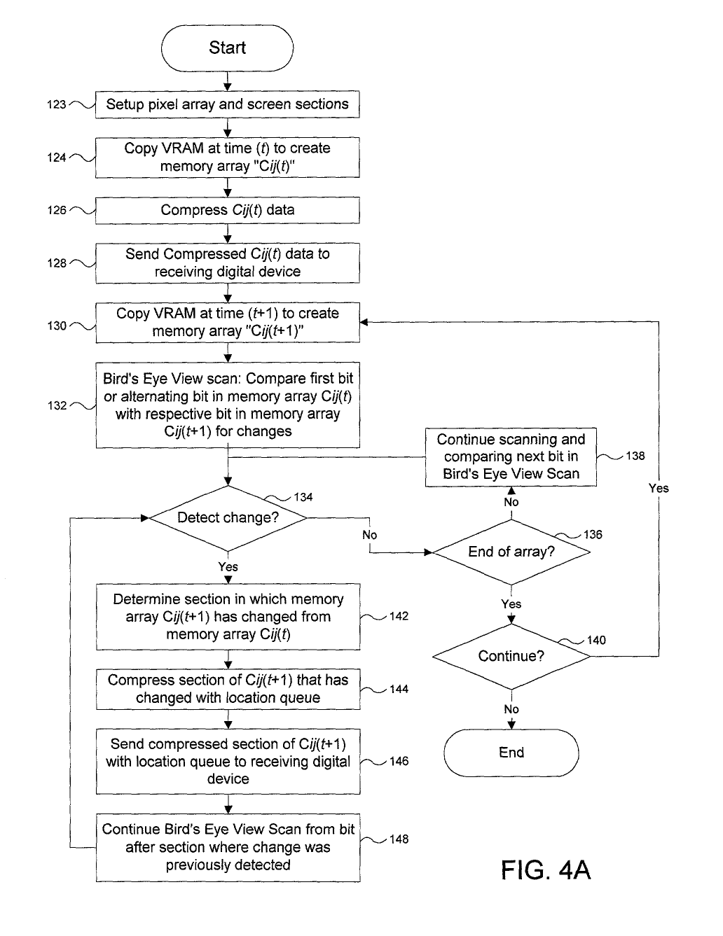

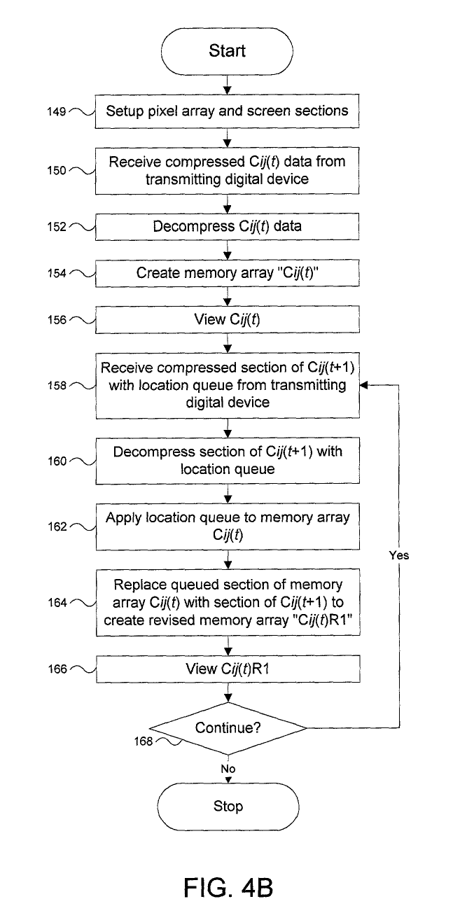

There are oftentimes where a sampling of each pixel in a video screen is not required for the desired resolution and speed constraints. In these situations, another method of the present invention is used. This method, the bird's eye view sampling process, is shown in FIG. 4A and FIG. 4B.

Referring now to FIG. 4A, the bird's eye view process begins at step 123, where the pixel array and screen sections are set up. This step is identical to step 49, described above with reference to FIG. 2A, and includes all preferred and alternate embodiments as described above. Next, in step 124, the VRAM is copied at time (t) to create a memory array Cij(t). This array represents frame 1/screen image 1 of the sequential video images running in VRAM. In step 126, the data in array Cij(t) is compressed, and then in step 128 the data is sent to the receiving digital device.

Next, in step 130, the VRAM is copied at time (t+1) to create a memory array Cij(t+1). The bird's eye view scanning process begins at step 132. The process is as follows. A comparison check for any differences is performed on both arrays, starting with the first bit in memory array Cij(t+1) and comparing it with the respective bit in memory array Cij(t). This first bit corresponds to any corner of the screen image or any midpoint within the memory array that is designated a starting point. In alternative embodiments, this first bit could also be a pixel represented by a series of bits or a cluster of pixels. If no change in the first bit in Cij(t+1) is detected in step 134 relative to Cij(t), then the next bit or pixel or cluster of pixels respectively in an interval of bits is scanned in step 138. The intervals are variable, and are selected by the user. This process continues for each bit of each pixel until the end of the array is reached in step 136 or a change is detected in step 134. When the end of the array is reached in step 136 and the process is continued, as determined in step 140, then the process repeats beginning with step 130 until it is discontinued, as determined in step 140.

The Cij(t+1) memory array is divided into predetermined sections. In the preferred embodiment, the screen image is divided into 12 sections where each section is 160×160 pixels each. This, in essence, creates a screen image bitmap. However, in other embodiments, the screen can be divided into any number of sections, and following, the number of pixels and corresponding bits in each section will vary depending on the size of the screen, and the number of screen sections. Each section is defined by a location queue consisting of i values and j values that identify a subset of the memory array Cij.

If a change is detected in step 134, then the section of Cij(t+1) in which the change occurred is determined in step 142. This data in this section, and the location queue of this section is compressed in step 144, and both are sent to the receiving digital device in step 146. Next, the comparison check process initiated in step 132 is continued in step 148 beginning with the next bit or pixel or cluster of pixels, respectively, in the interval that comes after the section where change was previously detected in step 134 of the previous cycle. This process continues a new cycle beginning again with step 134.

Referring now to FIG. 4B, a representation of the preferred embodiment of the bird's eye view process of the receiving digital device of the present invention is shown. The process begins at step 149 where the pixel array and the screen sections are set up. This step is identical to step 49, described above with reference to FIG. 2A, and includes all preferred and alternate embodiments as described above. Next, in step 150, the compressed Cij(t) array data is received from the transmitting digital device. In step 152 the receiving digital device decompresses the Cij(t) array data and, in step 154, this decompressed data is used to create memory array Cij(t). The Cij(t) memory array can then be entered into the receiving digital device's VRAM by any video application known in the art, as represented in step 156. Once entered into VRAM, the frame 1/screen image 1 of the sequential video images running in VRAM on the transmitting digital device can be displayed and viewed on any display device known in the art that is operated by the receiving digital device.

Next, in step 158, the receiving digital device receives the compressed section of the Cij(t+1) array data and the location queue data from the transmitting digital device. The receiving digital device decompresses the section of the Cij(t+1) array data and location queue data in step 160. In step 162, the receiving device determines, from the location queue data, the exact location of the section of the Cij(t+1) relative to the Cij(t) memory array. In step 164, the data from the queued section of memory array Cij(t) is replaced by the data from the section of Cij(t+1). This creates a revised memory array that is designated Cij(t)R1 in step 164.

The Cij(t)R1 memory array can then be entered into the receiving digital device's VRAM by any video application known in the art, as represented in step 166. Once entered into VRAM, the frame 1/screen image 1 of the sequential video images running in VRAM on the transmitting digital device can be displayed and viewed on any display device known in the art that is operated by the receiving digital device.

If the process is continued, as determined in step 168, then the process repeats beginning with step 158 until it is discontinued, as determined in step 168. Once all of the changed sections of Cij(t+1) are received and applied to the Cij(t) memory array, then revised Cij(t) memory array, represented by Cij(t)RX, will equal Cij(t+1) and can be viewed in step 166 as described above. This process is again repeated, beginning with step 158, for (t+3), (t+4) . . . (t+X) until it is discontinued, as determined in step 168.

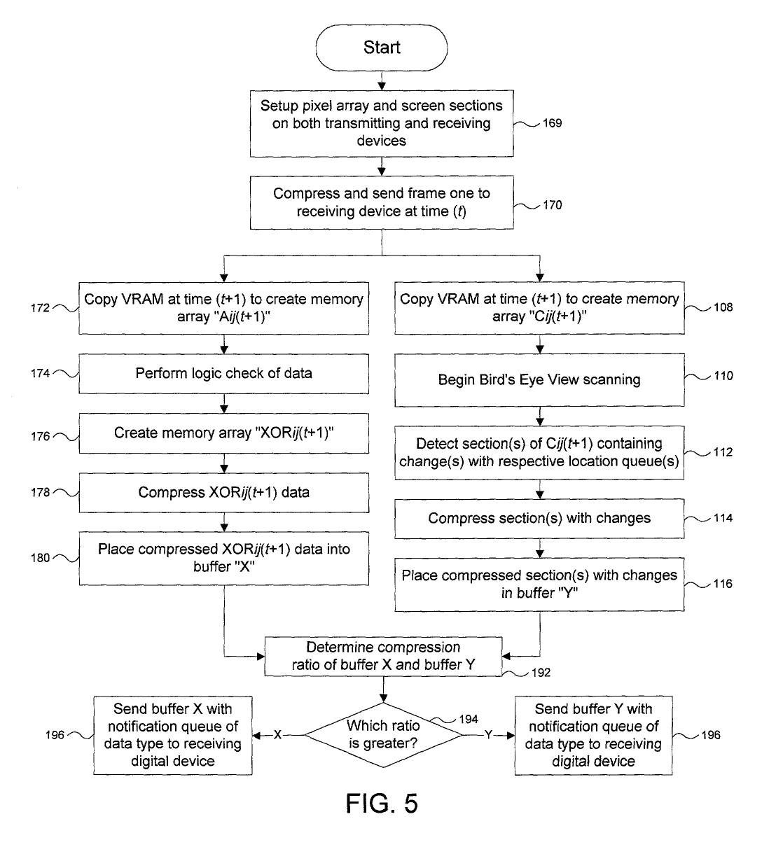

Referring next to FIG. 5, the process of utilizing both the XOR and the bird's eye view processes simultaneously is shown. The process starts at step 169 where the pixel array and the screen sections are set up. This step is identical to step 49, described above with reference to FIG. 2A, and includes all preferred and alternate embodiments as described above. Next, in step 170, the transmitting digital device compresses and sends the first frame of the video file to the receiving digital device. The separate but simultaneous processing by the XOR, beginning with step 172, and the bird's eye view, beginning with step 182, then begins.

In step 172, the VRAM is copied at time (t+1) to create a memory array Aij(t+1). In step 174, a logic check is performed on both arrays, Aij(t) and Aij(t+1). The resulting data from the logical process in step 174 is are used to create the new memory array XORij(t+1) in step 176 and this data is compressed in step 178 and placed in buffer X in step 180.

In step 182, the VRAM is copied at time (t+1) to create a memory array Cij(t+1). In step 184 Cij(t+1) array data is compared with Cij(t) array data using the bird's eye view scan to detect changes. In step 186, any sections where changes have been detected are identified and the data from each section is compressed in step 188. This compressed data is placed in buffer Y in step 190.

Next, in step 192, both the XOR process, beginning with step 172, and the sectional image process, beginning with step 182, merge, and the compression ratios for both buffer X and buffer Y are determined. In step 194, the buffer with the greatest compression ratio is selected, and in step 196, the selected buffer is sent along with a notification queue of the type of data, this being notification of either XOR data or sectional image data respectively, to the receiving digital device.

Although the above described methods and processes are described with respect to a transmitting digital device, and a receiving digital device, the scope of the present invention includes the transmission of the data to a multitude of receiving digital devices. Any digital device that can run the present invention can receive the transmitted data, and is intended to be within the scope of the present invention. Additionally, although the above methods and processes have been described with respect to frame 1 and frame 2 of a video, the scope of the above description and invention include a continuous exchange of frames from a video with frames 1, 2, 3, . . . z, where the transmitting device will transmit frames 1, 2, 3, . . . z to the receiving digital device using the above described processes and methods. Finally, although the above has been described with reference to copying VRAM in the first instance, the scope of the invention also includes other stored digital video information.

Storage devices suitable for tangibly embodying computer program instructions include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially designed ASICs (application-specific integrated circuits).

Other embodiments are within the scope of the following claims. For example, depending on the nature of the work items involved, the computer station may be a terminal, a hand held device or any variations thereof, instead of a personal computer.

The technique (i.e., the methods described above) may be implemented in hardware or software, or a combination of both. Preferably, the technique is implemented in computer programs executing on programmable computers that each include a processor, a storage medium readable by the processor (including volatile and nonvolatile memory and/or storage elements), at least one input device, and at least one output device. Program code is applied to data entered using the input device to perform the method described above and to generate output information. The output information is applied to one or more output devices.

Each program is preferably implemented in a high level procedural or object oriented programming language to communicate with a computer system. However, the programs can be implemented in assembly or machine language, if desired. In any case, the language may be a compiled or interpreted language.

Each such computer program is preferably stored on a storage medium or device (e.g., ROM, magnetic diskette, or CD) that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner.

Although the present invention has been described with reference to certain preferred embodiments thereof, other versions are readily apparent to those of ordinary skill in the art. Therefore, the spirit and scope of the appended claims should not be limited to the description of the preferred embodiments contained herein.

What is claimed is:

1. A computer system executable method for use in transmitting digital video stream from a transmitting device to at least one receiving device, said method comprising:
sending a first frame to said at least one receiving device;
comparing said first frame and a second frame for changed pixels;
determining changed and unchanged pixels;
coding said pixels to indicate said changed and unchanged pixels;
transmitting said code to said at least one receiving device; and
decoding said code and viewing said second frame on said at least one receiving device.

2. The method of claim 1, wherein said comparing further comprises comparing each bit of said pixels.

3. The method of claim 2, wherein said generating further comprises generating a code for said each bit of said pixels.

4. The method of claim 3, wherein said comparing further comprises scanning each pixel in said first frame and scanning each corresponding pixel from said second frame and performing a logic function on each of said pixels, whereby said logic function determines said changed and unchanged pixels.

5. The method of claim 3, wherein said comparing further comprises establishing an alternation pattern and scanning pixels corresponding to said alternation pattern in said first frame and scanning pixels in said second frame corresponding to said pixels in said first frame and performing a logic function on each of said pixels, whereby said logic function determines said changed and unchanged pixels.

6. The method of claim 3, wherein said transmitting further includes compressing said code.

7. The method of claim 6, wherein said decoding further includes decompressing said code.

8. A computer system executable method for use in transmitting digital video stream from a transmitting device to at least one receiving device, said method comprising:
storing a first frame in a reference memory in said transmitting device;
compressing said first frame;
transmitting said first frame to said at least one receiving device;
decompressing said first frame on at least one receiving device;
storing a second frame in a reference memory in said transmitting device;
comparing pixels in said first frame to corresponding pixels in said second frame;
determining changed and unchanged pixels from said first frame to said second frame;
based on said comparing and determining, generating a code to represent said changed and unchanged pixels;
compressing said code;
transmitting said code to said at least one receiving device;
decompressing said code on said at least one receiving device; and
decoding said code and viewing said second frame on said at least one receiving device.

9. The method of claim 8, wherein said comparing further comprises comparing each bit of said pixel to each bit of said corresponding pixel.

10. The method of claim 9, wherein said generating further comprises generating a code for said each bit of said pixel.

11. The method of claim 9, wherein said comparing further comprises scanning each pixel in said first frame and scanning each corresponding pixel from said second frame and performing a logic function on each of said pixels, whereby said logic function determines said changed and unchanged pixels.

12. The method of claim 9, wherein said comparing further comprises establishing an alternation pattern and scanning pixels corresponding to said alternation pattern in said first frame and scanning pixels in said second frame corresponding to said pixels in said first frame and performing a logic function on each of said pixels, whereby said logic function determines said changed and unchanged pixels.

13. A computer system executable method for use in transmitting digital video stream from a transmitting device to at least one receiving device, said method comprising:
a) storing a first frame in a reference memory in said transmitting device;
b) compressing said first frame;
c) transmitting said first frame to said at least one receiving device;
d) decompressing said first frame on at least one receiving device;
e) storing a second frame in a reference memory in said transmitting device;
f) comparing pixels in said first frame to corresponding pixels in said second frame;
g) determining changed and unchanged pixels from said first frame to said second frame;
h) based on said comparing and determining, generating a code to represent said changed and unchanged pixels;
i) compressing said code;
j) transmitting said code to said at least one receiving device;
k) decompressing said code on said at least one receiving device; and
l) decoding said code and viewing said second frame on said at least one receiving device.

14. The method of claim 13, wherein said comparing further comprises scanning each pixel in said first frame and scanning each corresponding pixel from said second frame and performing a logic function on each of said pixels, whereby said logic function determines said changed and unchanged pixels.

15. The method of claim 13, wherein said comparing further comprises establishing an alternation pattern and scanning pixels corresponding to said alternation pattern in said first frame and scanning pixels in said second frame corresponding to said pixels in said first frame and performing a logic function on each of said pixels, whereby said logic function determines said changed and unchanged pixels.

16. Computer software, residing on a computer readable storage medium, comprising instructions for use in a computer system for use in transmitting digital video stream from a transmitting device to at least one receiving device, the instructions causing the system to:
send a first frame to said at least one receiving device;
compare said first frame and a second frame for changed pixels;
determine changed and unchanged pixels;
code said pixels to indicate said changed and unchanged pixels;
transmit said code to said at least one receiving device; and
decode said code and viewing said second frame on said at least one receiving device.

17. The computer software of claim 16, wherein said instructions that compare further comprise comparing bits of said pixels.

18. The computer software of claim 17, wherein said instructions that compare further comprise scanning each pixel in said first frame and scanning each corresponding pixel from said second frame and performing a logic function on each of said pixels, whereby said logic function determines said changed and unchanged pixels.

19. The computer software of claim 17, wherein said instructions to compare further comprise establishing an alternation pattern and scanning pixels corresponding to said alternation pattern in said first frame and scanning pixels in said second frame corresponding to said pixels in said first frame and performing a logic function on each of said pixels, whereby said logic function determines said changed and unchanged pixels.

20. The computer software of claim 17, wherein said instructions to transmit further comprises compressing said code.

21. The computer software of claim 20, wherein said instructions to decode further comprises decompressing said code.

22. Computer software, residing on a computer readable storage medium, comprising instructions for use in a computer system for use in transmitting digital video stream from a transmitting device to at least one receiving device, the instructions causing the system to:
store a first frame in a reference memory in said transmitting device;
compress said first frame;
transmit said first frame to said at least one receiving device;
decompress said first frame on at least one receiving device;
store a second frame in a reference memory in said transmitting device;
compare pixels in said first frame to corresponding pixels in said second frame;
determine changed and unchanged pixels from said first frame to said second frame;
based on said compare and determine, generate a code to represent said changed and unchanged pixels;
compress said code;
transmit said code to said at least one receiving device;
decompress said code on said at least one receiving device; and
decode said code and viewing said second frame on said at least one receiving device.

23. The computer software of claim 22, wherein said instructions to compare further comprise comparing each bit of said pixel to each bit of said corresponding pixel.

24. The computer software of claim 23, wherein said instructions to generate further comprise generating a code for said each bit of said pixel.

25. Computer software, residing on a computer readable storage medium, comprising instructions for use in a computer system for use in transmitting digital video stream from a transmitting device to at least one receiving device, the instructions causing the system to:
a) store a first frame in a reference memory in said transmitting device;
b) transmit said first frame to said at least one receiving device;
c) store a second frame in a reference memory in said transmitting device;
d) compare said first frame and said second frame by comparing a pixel from said first frame to a corresponding pixel from said second frame, determining changed and unchanged bits in said pixel from said first frame and said corresponding pixel from said second frame and coding said changed and unchanged;
e) transmit said coding to said receiving device;
f) decode said coding on said receiving device; and
g) view said second frame on said receiving device.

26. The computer software of claim 25, wherein said instructions to scan further comprise scanning each pixel in said first frame and scanning each corresponding pixel from said second frame and performing a logic function on each of said pixels, whereby said logic function determines said changed and unchanged bits.

27. The computer software of claim 25, wherein said instructions to compare further comprise establishing an alternation pattern and scanning pixels corresponding to said alternation pattern in said first frame and scanning pixels in said second frame corresponding to said pixels in said first frame and performing a logic function on each of said pixels, whereby said logic function determines said changed and unchanged bits.

28. A computer system executable method for transmitting a digital video stream from a transmitting device to at least one receiving device, said method comprising:
dividing a first frame and a second frame into corresponding sections;
comparing each section for changed pixels;
determining a changed pixel in one of said second frame sections;
transmitting said section to said at least one receiving device; and
integrating said section into said first frame.

29. The method of claim 28, wherein said comparing further comprises comparing bits of said pixels.

30. The method of claim 29, wherein said transmitting further comprises compressing said section.

31. The method of claim 29, wherein said comparing further comprises performing a logic function on each of said pixels, whereby said logic function determines said changed pixels.

32. The method of claim 29, wherein said comparing further comprises establishing an alternation pattern and scanning pixels corresponding to said alternation pattern in said first frame and scanning pixels in said second frame corresponding to said pixels in said first frame and performing a logic function on each of said pixels, whereby said logic function determines said changed pixels.

33. A computer system executable method for transmitting a digital video stream from a transmitting device to at least one receiving device, said method comprising:
dividing a first frame and a second frame into corresponding sections;
storing said first frame in a reference memory in said transmitting device;
compressing said first frame;
transmitting said first frame to said at least one receiving device;
decompressing said first frame on at least one receiving device;
storing said second frame in a reference memory in said transmitting device;
comparing pixels in a first section of said first frame to a corresponding section in said second frame;
determining a changed pixel from a difference in at least one pixel between said first section of said first frame to said corresponding section in said second frame, if said changed pixel determined;
compressing said corresponding section in said second frame;
transmitting said corresponding section in said second frame to said at least one receiving device;
decompressing said corresponding section;
integrating said decompressed corresponding section into said first frame stored in said reference memory of said at least one receiving device;
storing said integrated first frame in said reference memory; and
repeating process with another pair of sections subsequent to the previously processed pair of sections until each section of the first frame and the second frame has been processed.

34. The method of claim 30, wherein said comparing further comprises comparing bits of said pixels.

35. The method of claim 34, wherein said comparing further comprises performing a logic function on each of said pixels, whereby said logic function determines said changed pixel.

36. The method of claim 34, wherein said comparing further comprises establishing an alternation pattern and scanning pixels corresponding to said alternation pattern in said first frame and scanning pixels in said second frame corresponding to said pixels in said first frame and performing a logic function on each of said pixels, whereby said logic function determines said changed pixel.

37. A method for transmitting a digital video stream from a transmitting device to at least one receiving device, said method comprising:
a) dividing a first frame and a second frame into corresponding sections;
b) storing said first frame in a reference memory in said transmitting device;
c) compressing said first frame;
d) transmitting said first frame to said at least one receiving device;
e) decompressing said first frame on at least one receiving device;
f) storing said second frame in a reference memory in said transmitting device;
g) comparing pixels in a first section of said first frame to a corresponding section in said second frame;
h) determining a changed pixel from a difference between said first section of said first frame to said corresponding section in said second frame, if said changed pixel determined;
i) compressing said first section in said second frame;
j) transmitting said corresponding section in said second frame to said at least one receiving device;
k) decompressing said corresponding section;
l) integrating said corresponding section into said first frame stored in said reference memory of said at least one receiving device;
m) storing said integrated first frame in said reference memory;
n) repeating steps g-m with another pair of sections subsequent to the previously processed pair of sections until each section of the first frame and the second frame has been processed;
m) repeating steps a-n with another frame of said video stream subsequent to the previously processed frame.

38. The method of claim 37, wherein said comparing further comprises comparing bits of said pixels.

39. The method of claim 38, wherein said comparing further comprises performing a logic function on each of said pixels, whereby said logic function determines said changed pixel.

40. The method of claim 38, wherein said comparing further comprises establishing an alternation pattern and scanning pixels corresponding to said alternation pattern in said first frame and scanning pixels in said second frame corresponding to said pixels in said first frame and performing a logic function on each of said pixels, whereby said logic function determines said changed pixel.

41. Computer software, residing on a computer-readable storage medium, comprising instructions for use in a computer system for use in transmitting a digital video stream from a transmitting device to at least one receiving device, the instructions causing the system to:
divide a first frame and a second frame into corresponding sections;
compare said sections for changed pixels;
determine a changed pixel in one of said second frame sections;
transmit said second frame sections to said at least one receiving device; and
integrate said section into said first frame.

42. The computer software of claim 41, wherein said instructions to compare further comprise instructions to compare bits of said pixels.

43. The computer software of claim 42, wherein said instructions to compare further comprises performing a logic function on each of said pixels, whereby said logic function determines said changed pixels.

44. The computer software of claim 42, wherein said instructions to compare further comprises establishing an alternation pattern and scanning pixels corresponding to said alternation pattern in said first frame and scanning pixels in said second frame corresponding to said pixels in said first frame and performing a logic function on each of said pixels, whereby said logic function determines said changed pixels.

45. Computer software, residing on a computer-readable storage medium, comprising instructions for use in a computer system for use in transmitting a digital video stream from a transmitting device to at least one receiving device, the instructions causing the system to:
divide a first frame and a second frame into corresponding sections;
store said first frame in a reference memory in said transmitting device;
compress said first frame;
transmit said first frame to said at least one receiving device;
decompress said first frame on at least one receiving device;
store said second frame in a reference memory in said transmitting device;
compare pixels in a first section of said first frame to a corresponding section in said second frame;
determine a changed pixel from a difference between said first section of said first frame to said corresponding section in said second frame, if said changed pixel determined;
compress said corresponding section in said second frame;
transmit said corresponding section in said second frame to said at least one receiving device;
decompress said corresponding section;
integrate said decompressed corresponding section into said first frame stored in said reference memory of said at least one receiving device;
store said integrated first frame in said reference memory; and
repeat process with another pair of sections subsequent to the previously processed pair of sections until each section of the first frame and the second frame has been processed.

46. The computer software of claim 45, wherein said instructions to compare further comprise instructions to compare bits of said pixels.

47. The computer software of claim 46, wherein said instructions to compare further comprise performing a logic function on each of said pixels, whereby said logic function determines said changed pixel.

48. The computer software of claim 46, wherein said instructions to compare further comprise establishing an alternation pattern and scanning pixels corresponding to said alternation pattern in said first frame and scanning pixels in said second frame corresponding to said pixels in said first frame and performing a logic function on each of said pixels, whereby said logic function determines said bit changes.

49. Computer software, residing on a computer-readable storage medium, comprising instructions for use in a computer system for use in transmitting a digital video stream from a transmitting device to at least one receiving device, the instructions causing the system to:
a) divide a first frame and a second frame into corresponding sections;
b) store said first frame in a reference memory in said transmitting device;
c) compress said first frame;
d) transmit said first frame to said at least one receiving device;
e) decompress said first frame on at least one receiving device;
f) store said second frame in a reference memory in said transmitting device;
g) compare pixels in a first section of said first frame to a corresponding section in said second frame;
h) determine a changed pixel from a difference between said first section of said first frame to said corresponding section in said second frame, if said changed pixel determined;
i) compress said corresponding section in said second frame;
j) transmit said corresponding section to said at least one receiving device;
k) decompress said corresponding section;
l) integrate said decompressed corresponding section into said first frame stored in said reference memory of said at least one receiving device;
m) store said integrated first frame in said reference memory;
n) repeat steps g-m with another pair of sections subsequent to previously processed pair of sections until each section of said first frame and said second frame has been processed;
m) repeat steps a-n with another frame of said video stream subsequent to previously processed frame.

50. The computer software of claim 49, wherein said instructions to compare further comprise instructions to compare bits of said pixels.

51. The computer software of claim 50, wherein said instructions to compare further comprise instructions to perform a logic function on each of said pixels, whereby said logic function determines said changed pixel.

52. The computer software of claim 50, wherein said instructions to compare further comprise establish an alternation pattern and scan pixels corresponding to said alternation pattern in said first frame and scan pixels in said second frame corresponding to said pixels in said first frame and perform a logic function on each of said pixels, whereby said logic function determines said changed pixel.

53. A computer system executable method for use in transmitting digital video stream from a transmitting device to at least one receiving device, said method comprising:
completing a first processing, said first processing comprising:
compressing a first frame of said video stream;
sending said first frame to said receiving device;
comparing a first frame and a second frame for changed pixels;
determining changed and unchanged pixels;
coding said pixels to indicate said changed and unchanged pixels;
compressing said code; and
storing said code in a first buffer;
completing a second processing, said second processing comprising:
dividing a first frame and a second frame into corresponding sections;
comparing each section for changed pixels;
determining a changed pixel in one of said second frame sections;
transmitting said section to a second buffer;
compressing said second buffer;
determining a compression ratio for each of said first buffer and said second buffer; and
sending buffer with a greater compression ratio to said at least one receiving device;
if said first buffer is sent, decompressing said first buffer and decoding said code and viewing said second frame on said at least one receiving device; and
if said second buffer is sent, decompressing said second buffer and integrating said section into said first frame on said at least one receiving device and viewing said second frame on said at least one receiving device.

54. The method of claim 53, wherein said comparing further comprises comparing bits of said pixels.

55. The method of claim 54, wherein said first processing comparing further comprises scanning each pixel in said first frame and scanning each corresponding pixel from said second frame and performing a logic function on each of said pixels, whereby said logic function determines said changed and unchanged pixels.

56. The method of claim 54, wherein said second processing comparing further comprises establishing an alternation pattern and scanning pixels corresponding to said alternation pattern in said first frame and scanning pixels in said second frame corresponding to said pixels in said first frame and performing a logic function on each of said pixels, whereby said logic function determines said changed pixel.

57. Computer software, residing on a computer-readable storage medium, comprising instructions for use in a computer system for use in transmitting digital video stream from a transmitting device to at least one receiving device, the instructions causing the system to:
complete a first process, said first process includes instructions causing the system to:
compress a first frame of said video stream;
send said first frame to said receiving device;
compare a first frame and a second frame for changed pixels;
determine changed and unchanged pixels;
code said pixels to indicate said changed and unchanged pixels;
compress said code; and
store said code in a first buffer;
complete a second process, said second process instructions causing the system to:
divide said first frame and said second frame into corresponding sections;
compare each section for changed pixels;
determine a changed pixel in one of said second frame sections;
transmit said section to a second buffer;
compress said second buffer;
determine compression ratio for each of said first buffer to said second buffer;
send buffer with a greater compression ratio to said at least one receiving device;
if said first buffer is sent, decompress said first buffer and decode said code and view said second frame on said at least one receiving device; and
if said second buffer is sent, decompress said second buffer and integrate said section into said first frame, and view said second frame on at least one receiving device.

58. The computer software of claim 57, wherein the first process instructions to compare further comprise compare bits of said pixels.

59. The computer software of claim 58, wherein the first process instructions to compare further comprise scan each pixel in said first frame and scan each corresponding pixel from said second frame and perform a logic function on each of said pixels, whereby said logic function determines said changed and unchanged pixels.

60. The computer software of claim 58, wherein the second process instructions to compare further comprise establishing an alternation pattern and scanning pixels corresponding to said alternation pattern in said first frame and scanning pixels in said second frame corresponding to said pixels in said first frame and performing a logic function on each of said pixels, whereby said logic function determines said changed pixel.
